(19) United States
(12) Patent Application Publication
(10) Pub. No.: US 2006/0187886 A1
(43) Pub. Date: Aug. 24, 2006

(54) Power-efficient transmission method for forward link control channels of wireless networks

(76) Inventors: Francis Dominique, Rockaway, NJ (US); Hongwei Kong, Denville, NJ (US); Ashok Armen Tikku, Morristown, NJ (US)

Correspondence Address: Lucent Technologies Inc.;Docket Administrator - Room 3J-219, 101 Crawfords Corner Road, Holmdel, NJ, 07733-3030, US

(21) Appl. No.: 11/062,097

(22) Filed: Feb. 18, 2005

(51) Int. Cl. H04B 7/216

(52) U.S. Cl. 370/335; 370/342

(57) ABSTRACT

A method for transmitting to a user terminal of a wireless communication network includes the determination of a transmit power for the message to be transmitted. The transmit power includes a margin that is determined adaptively. In specific embodiments of the invention, the margin is adapted in response to a measurement of the frequency of error events so as to urge such frequency below a specified upper bound.

### FIELD OF THE INVENTION

The invention relates to power allocation on the forward link control channel of a wireless network such as a CDMA network.

### ART BACKGROUND

In some wireless networks, particularly CDMA networks, control messages are sent by the network to the users on a forward link control channel that is time-shared among multiple users. In networks described by Revision C of the CDMA2000 third-generation standard, for example, a user receiving data on a packet data channel must successfully decode information sent on the control channel before it can successfully decode the data sent to it on the packet data channel. Therefore, the user can receive data only if the control information is transmitted with enough power to be reliably decoded.

However, forward-link transmission power is a finite resource. Therefore, it is desirable to allocate power in such a way as to compensate for poor channel quality, where needed, while conserving the overall average power. That is, weaker transmissions are made to those users for which the channel is good, and stronger transmissions are made to those users for which the channel is poor.

According to one known approach, a computation is made of the signal power x required at the receiver in order for the receiver error rate to satisfy a specified upper bound. This target power can readily be computed from known system properties such as the repetition rate and the type of coding used. This target power is multiplied by a factor obtained by inverting the propagation channel, to compensate for fading. The result is multiplied by a safety margin T, which is intended to compensate, e.g., for inaccuracy in the estimated channel coefficients and in the statistical modeling of the channel. That is, if the current channel estimate is represented by the symbol cqi, and if all quantities are understood to be logarithmic, the target power is given by the expression x−cqi+T. In Revision C of the CDMA2000 (3GPP2) standard, the mobile reports its channel quality on the Reverse Channel Quality Indicator Channel, and we refer to that report as the cqi.

The margin needed to achieve the target error rate depends on several factors, including, e.g., the rate of change of cqi reports due to user mobility, and multipath effects.

Computational delay is usefully avoided by precomputing and storing representative values of T. However, such precomputation may involve crude approximations, in view of which the safety margins are set unnecessarily high. Moreover, such precomputation may fail to consider some channel conditions encountered in the field.

Thus, there remains a need for a method of forward-link transmission that offers greater flexibility in the setting of the safety margin T.

### SUMMARY OF THE INVENTION

We have found such a method. According to our invention in a broad aspect, T is set adaptively. In specific embodiments of the invention, an error count is accumulated in each of a series of successive time windows, and T is adjusted upward or downward in response to at least some said error counts. A message is formulated for transmission on the forward link. Prior to transmission, a transmit power level is determined for the message. The adapted value of T is included in the transmit power level.

### BRIEF DESCRIPTION OF THE DRAWING

FIG. 1 is a flowchart of a method for adapting the value of T according to the invention in an illustrative embodiment.

FIGS. 2 and 3 are graphs showing the adaptation of T over time in two numerical simulations.

### DETAILED DESCRIPTION

We assume that the user, which is typically a mobile terminal, provides periodic reports of channel conditions at discrete times t. Because of latency in the network, a cqi report received at, e.g., the base station at time t will actually correspond to the network condition at an earlier time t−d, wherein d is the reporting delay. Herein, the symbol Cₑₛₜ(t) will represent the most up-to-date channel information available to, e.g., the base station at time t. If an estimator is used to counteract the latency by providing predictive estimates, then cₑₛₜ(t) will represent the most recent estimated cqi report. On the other hand, the symbol c(t) will represent the cqi report as formulated at time t. Thus, an estimator will produce an estimate of c(t) based on cqi measurements c(t−d) and possibly on older measurements c(t−d−1), c(t−d−2), etc.

We will now describe a method which responds to the cqi reports by adapting the value of T. Significantly, the method to be described is independent of any model of the propagation channel. As a consequence, it is versatile and robust to channel behavior that deviates significantly from idealized statistical models.

Initially, we recall from the above discussion that the target signal power for transmission will be (in logarithmic notation) x−cqi+T. If the safety margin is set at time t such that (in logarithmic notation) Cₑₛₜ(t)=T+c(t), then substituting the last expression in place of cqi gives a target transmit power of x−c(t), and a corresponding received signal power of x. Thus, the signal power at the receiver will fall short of the desired level x whenever Cₑₛₜ(t)>T+c(t). That is, there will be a power shortfall at the receiver when, in a certain sense, the channel quality is overestimated.

Errors are more likely to occur when there is such a power shortfall. In our approach, we take certain events as indicative of error, or of the likelihood of error. From the history of these events, we determine when the likelihood of error is too high, and we respond by raising the value of T.

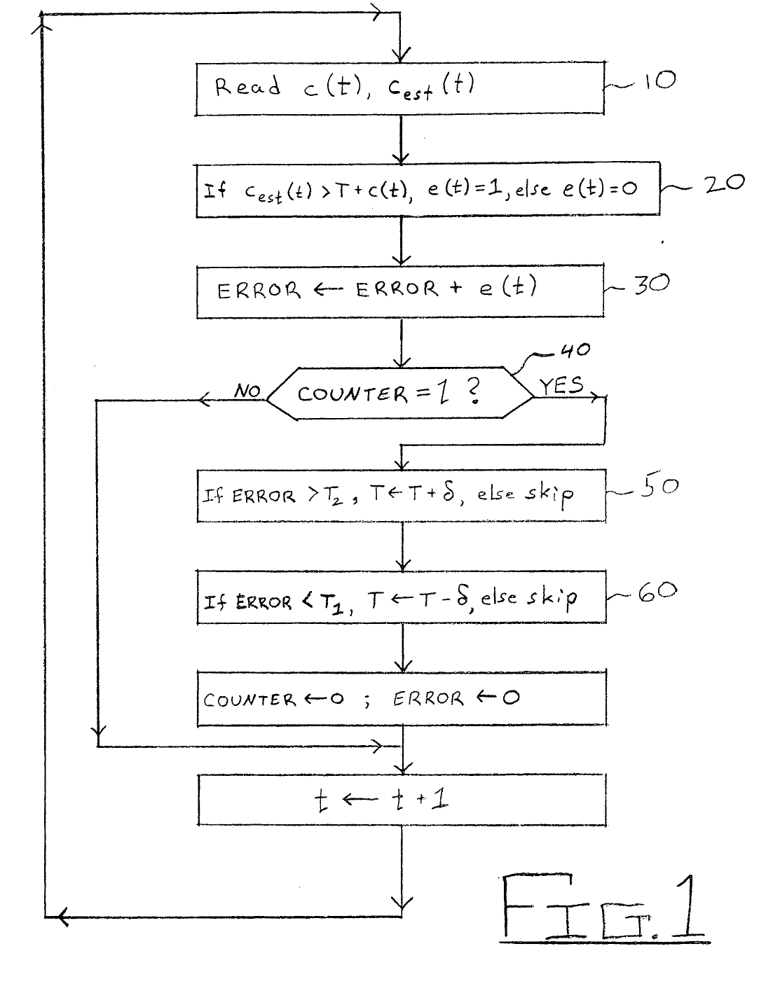

In an illustrative embodiment of the present invention as depicted in FIG. 1, T is adapted according to a procedure that urges it to satisfy a probabilistic bound. The probabilistic bound is that the likelihood of overestimating the channel quality (in the sense described above) must not exceed an upper bound [symbol] . This may be stated mathematically by, Pr[cₑₛₜ(t)>T+c(t)]< [symbol] . The upper bound [symbol] may be chosen, for example, to be a target error rate, or a value related thereto.

T is dynamically adapted to keep the above-stated probability within the specified bound.

To determine when T should be increased, an estimator keeps track of a count of error events in each of a series of successive time windows. According to the present example, the error event e(t) has the value 1 if Cₑₛₜ(t)>T+c(t), and otherwise has the value 0. This is shown in box 20 of FIG. 1.

In order to evaluate e(t), it will be necessary to store Cₑₛₜ(t) for d time increments, i.e., for the reporting delay until c(t) becomes available. For example, the estimator may read (box 10) Cₑₛₜ (t) from a buffer or memory.

To count error events, we define for our estimator a time window of length l time increments. The accumulation of the error count “ERROR” over the time window is shown in box 30 of the figure. In the figure, counter 40 defines the time window.

To assure an error rate of no more than 1%, for example, we might wish to adapt T such that there are no more than 0.01 γl error events per time window. For that purpose, we set a pair of thresholds T₁, T₂, such that T₁<0.01 γl<T₂. For example, we might use l=500, T₁=3, T₂=7, or (relaxing the strict inequality for T₁) l=100, T₁=1, T₂=2. Below, we will refer to the first set of conditions as Case I, and to the second set as Case II. In response to each time window, we increase T(box 50) if more than T₂ error events occur, and we decrease T (box 60) if fewer than T₁ error events occur. An exemplary step size for T is 1 dB. Those skilled in the art will recognize that alternatively to a fixed step size, the step size can be adapted according to known methods. The step size is referred to as “δ” in boxes 50 and 60 of FIG. 1.

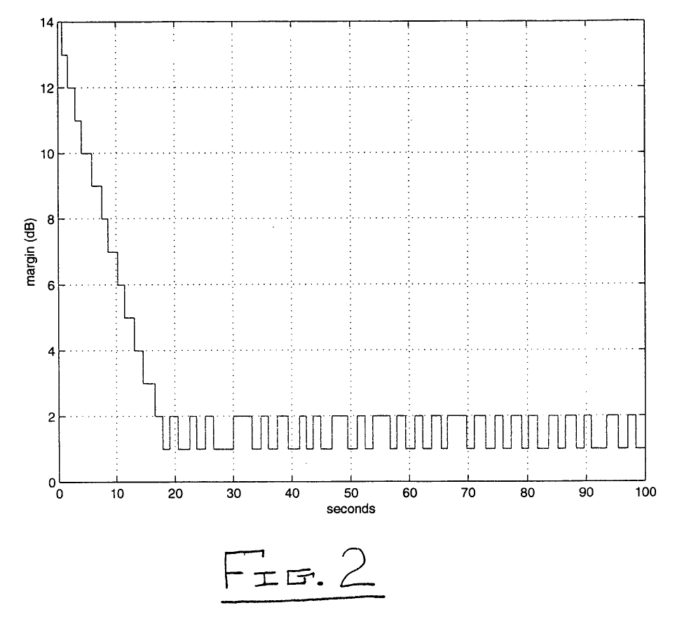

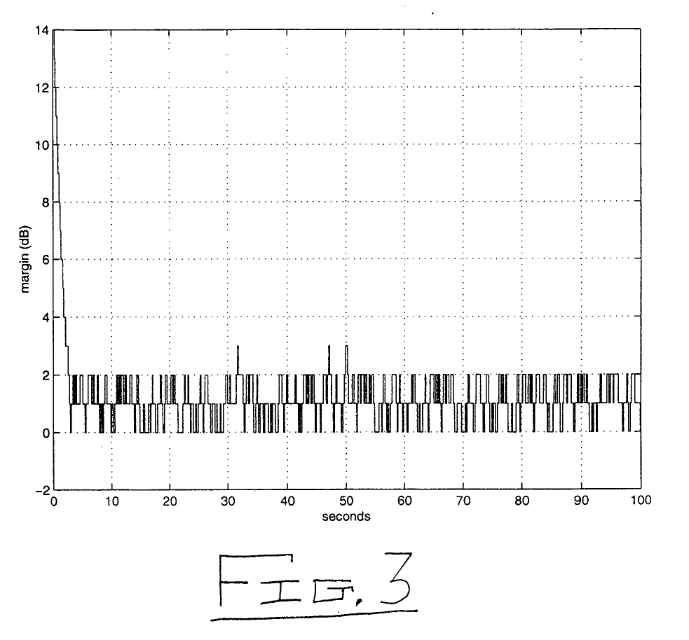

FIGS. 2 and 3 show the time evolution of T in a simulated network in which the user is traveling at 3 kph. To account for the fact that transmissions will be made to a given user only at times when the channel to that user is of good quality, the simulation considers only that 50% of predicted cqi values which lie above the mean cqi. FIG. 2 corresponds to Case I, and FIG. 3 corresponds to Case II as defined above. The step size in both cases is 1 dB.

Various techniques may be used to improve the rate of convergence of T without departing from the spirit and scope of the invention. One technique, mentioned above, is to adapt the step size. Another technique is to employ multiple estimators whose time windows have different lengths 1. Thus, a low-resolution estimator having, e.g., l=100, can be used for fast initial convergence, and a high-resolution estimator, having, e.g., l=500, can be used thereafter for greater accuracy. Yet another technique is to use multiple parallel estimators having the same time window. One estimator has an adaptable T, as described above, but the others have fixed values of T that are distributed uniformly over a range of possible values for the optimal margin. The adaptive estimator can then compare its error count with the error counts of the fixed estimators. It can use this information to set T more accurately upon startup or when the channel changes.

The techniques described above can be modified in numerous ways without departing from the scope and spirit of the invention. For example, the estimator may count error events of alternative kinds to the error event e(t) described above. In further examples, the estimator may work by measuring time intervals between error events, rather than by counting over time windows.

It will be understood that a digital processor for performing the estimator function and the adaptation of T may be implemented as, for example and without limitation, a computer operating under control of an appropriate software program, or an application specific device operating under appropriate hardware or firmware control.

Although the standard CDMA2000 Rev. C has been expressly mentioned above, the invention is not limited to systems described by that standard. Other contexts in which the invention will be useful include, without limitation, those described by UMTS 3GPP Releases 5 and 6, and CDMA2000 Rev. D.

What is claimed is:

1. A method for transmitting to a user terminal of a wireless communication network, comprising formulating a message, determining a transmit power for the message which includes a margin T, and transmitting the message, wherein the determination of the transmit power comprises determining T adaptively.

2. The method of claim 1, wherein T is adapted in response to a measurement of the frequency of error events so as to urge such frequency below a specified upper bound.

3. The method of claim 2, wherein the frequency of error events is determined by accumulating an error count in each of a series of successive time windows.

4. The method of claim 2, wherein each error event corresponds to an overestimation of channel quality.

5. The method of claim 4, wherein the channel quality is expressed by a cqi value, and the overestimation is due to an estimated value Cₑₛₜ(t) of the cqi at time t exceeding the actual value c(t) of the cqi at time t.

6. The method of claim 5, wherein:
the overestimation is described by the inequality Cₑₛₜ(t)>T+c(t), in which the quantities being added and compared are logarithmic.
